(19) United States
(12) Patent Application Publication
(10) Pub. No.: US 2015/0208713 A1
(43) Pub. Date: Jul. 30, 2015

(54) Agricultural Apparatus For Collecting, Cutting and/or Processing Produce and Methods Thereof

(71) Applicant: Freshway Innovation, LLC, Sidney, OH (US)

(72) Inventors: Philip M. Gilardi, Sidney, OH (US); Travis W. Brux, Sidney, OH (US); Robert E. Douglass, West Milton, OH (US)

(73) Assignee: FRESHWAY INNOVATION, LLC, Sidney, OH (US)

(21) Appl. No.: 14/607,315

(22) Filed: Jan. 28, 2015

Related U.S. Application Data
(60) Provisional application No. 61/932,416, filed on Jan. 28, 2014.

(51) Int. Cl. A23N 15/04

(52) U.S. Cl. CPC A23N 15/04

(57) ABSTRACT

Agricultural apparatuses for collecting, cutting, and/or processing produce. The agricultural apparatus include a feed conveyor, a first belt, a second belt, where the second belt is spaced apart from the first belt, a processing station, the processing station including a housing mounted to the feed conveyor, a first rotating blade, and a second rotating blade that is spaced apart from the first rotating blade, where the first rotating blade and the second rotating blade are at least partially encapsulated by the housing.

### CROSS REFERENCE TO RELATED APPLICATIONS

The present application claims the benefit of and priority to U.S. Provisional Patent Application 61/932,416 entitled “Agricultural Apparatus for Collecting, Cutting and/or Processing Produce and Methods Thereof,” which was filed on Jan. 28, 2014, the entirety of which is herein incorporated by reference.

### TECHNICAL FIELD

The present application generally relates to agricultural apparatus, and more particularly, relates to agricultural apparatus for collecting, cutting, and/or processing produce and to methods thereof.

### BACKGROUND

Many types of produce, e.g., romaine lettuce, are harvested by hand. After harvesting, such produce may require further treatment, e.g., collecting, cutting, and/or processing. With regard to romaine lettuce, for example, once harvested, it may be desirable to remove a top portion thereof prior to collection. Such removal, however, may require cutting a head of romaine lettuce by hand with a cutting tool, making multiple cuts across the head. This practice can lead to uneven surfaces across the head and/or variation amongst the finished products.

Accordingly, additional embodiments related to agricultural apparatus for collecting, cutting, and/or processing produce and to methods thereof are desired.

### SUMMARY

In one embodiment, an agricultural apparatus for collecting, cutting, and/or processing produce, the agricultural apparatus including a feed conveyor that extends between a loading end and a delivery end in a longitudinal direction, where the feed conveyor includes a first belt that extends between the loading end and the delivery end of the feed conveyor in the longitudinal direction, and a second belt that extends between the loading end and the delivery end of the feed conveyor in the longitudinal direction, where the second belt is spaced apart from the first belt in a lateral direction, and a processing station, the processing station including a housing mounted to the feed conveyor, an axle attached to the feed conveyor, a first rotating blade operatively connected to the axle, and a second rotating blade operatively connected to the axle, where the second rotating blade is spaced apart from the first rotating blade in the lateral direction, and where the first rotating blade and the second rotating blade are positioned between the first belt and the second belt in the lateral direction and are at least partially encapsulated by the housing, where the first rotating blade and the second rotating blade cut through produce passing from the loading end to the delivery end of the feed conveyor.

In another embodiment, an agricultural apparatus for collecting, cutting, and/or processing produce, the agricultural apparatus including a feed conveyor that extends between a loading end and a delivery end in a longitudinal direction, where the feed conveyor includes a first belt that extends between the loading end and the delivery end of the feed conveyor in the longitudinal direction, and a second belt that extends between the loading end and the delivery end of the feed conveyor in the longitudinal direction, where the second belt is spaced apart from the first belt in a lateral direction, and a processing station, the processing station including a housing mounted to the feed conveyor, an axle attached to the feed conveyor, a first rotating blade operatively connected to the axle, and a second rotating blade operatively connected to the axle, where the second rotating blade is spaced apart from the first rotating blade in the lateral direction, where the first rotating blade and the second rotating blade are at least partially encapsulated by the housing and where the first rotating blade and the second rotating blade cut through produce passing from the loading end to the delivery end of the feed conveyor, and a spray nozzle that dispenses a fluid, where the spray nozzle is coupled to the feed conveyor and positioned between the first rotating blade and the second rotating blade in the lateral direction.

In yet another embodiment, an agricultural apparatus for collecting, cutting, and/or processing produce, the agricultural apparatus including a feed conveyor that extends between a loading end and a delivery end in a longitudinal direction, the feed conveyor including a top surface that extends between the loading end and the delivery end in the longitudinal direction, a first side wall that extends upward from the top surface in a vertical direction, a first side rail that is movably attached to the first side wall, the first side rail including a rail portion that extends in the longitudinal direction and a slide portion that extends in a lateral direction, where the slide portion is operatively connected to the rail portion and is movably attached to the first side wall such that the rail portion is selectively translatable with respect to the first side wall in the lateral direction, a first belt that extends between the loading end and the delivery end of the feed conveyor in the longitudinal direction, and a second belt that extends between the loading end and the delivery end of the feed conveyor in the longitudinal direction, where the second belt is spaced apart from the first belt in the lateral direction, and a processing station, the processing station including a housing mounted to the feed conveyor, an axle attached to the feed conveyor, a first rotating blade operatively connected to the axle, and a second rotating blade operatively connected to the axle, where the first rotating blade and the second rotating blade cut through produce passing from the loading end to the delivery end of the feed conveyor.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, in which:

FIG. 1A is a front view of an agricultural apparatus for collecting, cutting, and/or processing produce, e.g., romaine lettuce, according to one or more embodiments shown or described herein;

FIG. 1B is a front view of an agricultural apparatus for collecting, cutting, and/or processing produce, e.g., romaine lettuce, including one or more flighted belts according to one or more embodiments shown or described herein;

FIG. 2 is a perspective view of the agricultural apparatus of FIG. 1A, with an enlarged view of rotating blades and a cutting block according to one or more embodiments shown or described herein;

FIG. 3 is an enlarged perspective view of the rotating blades of the agricultural apparatus of FIG. 2 according to one or more embodiments shown or described herein;

FIG. 4 is a front perspective view of the agricultural apparatus and the rotating blades of FIG. 3 according to one or more embodiments shown or described herein;

FIG. 5 is a top view of an agricultural apparatus for collecting, cutting, and/or processing produce with spray nozzles and side rails according to one or more embodiments shown or described herein;

FIG. 6 is a side perspective view of an agricultural apparatus for collecting, cutting, and/or processing produce with rotating blades on outer edges of a feed conveyor according to one or more embodiments shown or described herein; and

FIG. 7 is a top perspective view of processed romaine lettuce.

### DETAILED DESCRIPTION

Embodiments of the present disclosure are directed toward agricultural apparatus for collecting, cutting, and/or processing produce, e.g., romaine lettuce, and to methods thereof. Reference will now be made in detail to embodiments of agricultural apparatus for collecting, cutting, and/or processing produce (hereinafter, “agricultural apparatus”). As used herein, the term “agricultural apparatus” refers to a stationary system and/or a mobile system for use in a processing facility and/or a field. When used in a processing facility, for example, produce may be harvested in a field, transported from the field to the processing facility, and collected, cut, and/or processed therein. When used in a field, however, produce may be harvested, collected, cut, and/or processed therein. Additionally, in the field, the agricultural apparatus may be removably mounted to farm equipment, e.g., a tractor, harvester, and/or trailer, and may include wheels such that it may be towed behind the farm equipment. In some embodiments, the agricultural apparatus is used in a field only, and is not used in a processing facility.

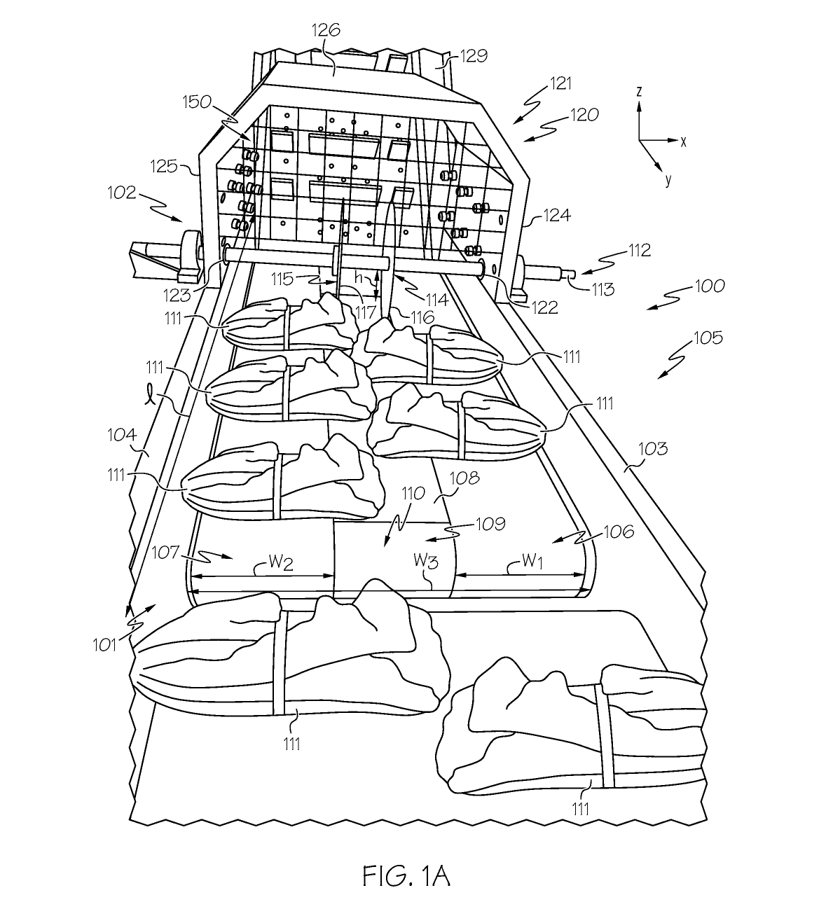

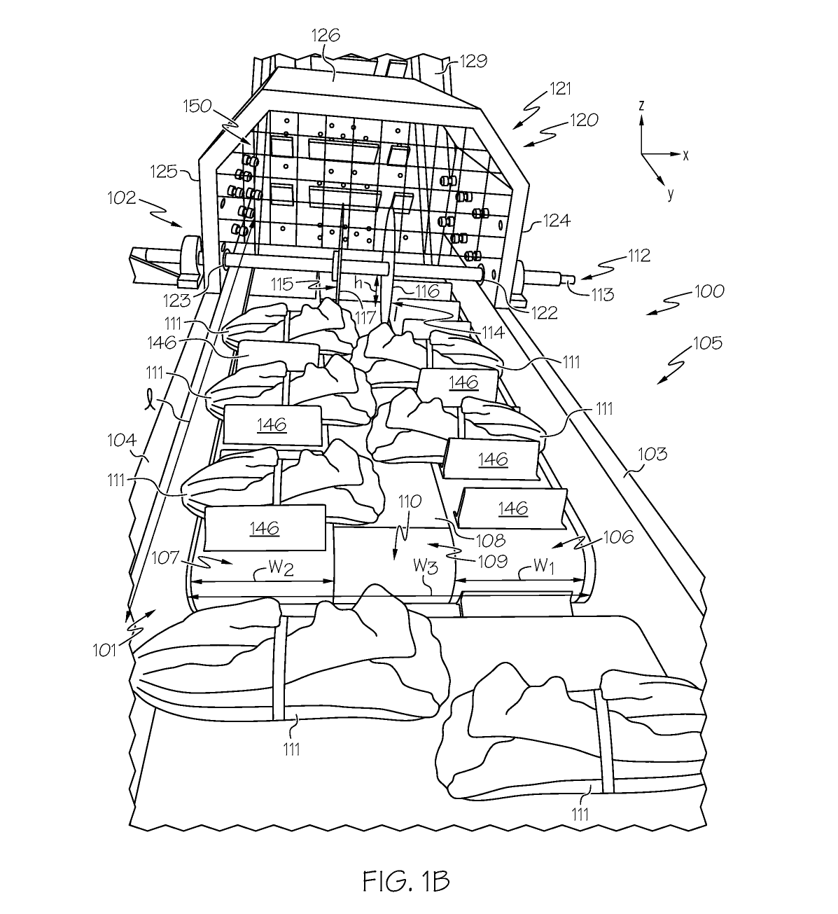

Embodiments of agricultural apparatus will now be described in detail with reference to FIGS. 1-6. Thereafter, embodiments of methods of collecting, cutting, and/or processing produce will be described with reference to FIGS. 1-7.

As used herein, the term “longitudinal direction” refers to the forward-rearward direction of the agricultural apparatus (i.e., in the +/−Y-direction as depicted). The term “lateral direction” refers to the cross-direction (i.e., in the +/−X-direction as depicted), and is transverse to the longitudinal direction. The term “vertical direction” refers to the upward-downward direction of the agricultural apparatus (i.e., in the +/−Z-direction as depicted).

### I. Agricultural Apparatus

Referring initially to FIG. 1A, in one or more embodiments, an agricultural apparatus 100 includes a feed conveyor 105, a processing station 120 operatively connected to the feed conveyor 105, and/or a collection conveyor 129 operatively connected to the processing station 120 and/or to the feed conveyor 105. Embodiments of the feed conveyor 105 will now be described in detail with reference to FIGS. 1A-6.

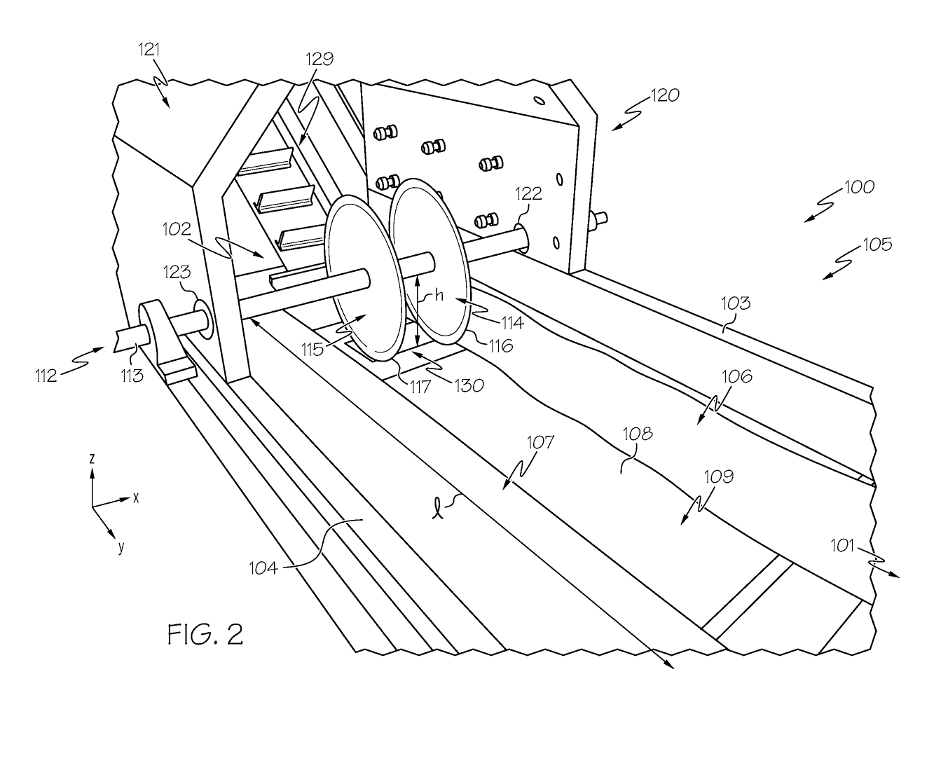

Referring collectively to FIGS. 1A, 1B, and 2, in one or more embodiments, the agricultural apparatus 100 includes the feed conveyor 105. In some embodiments, the feed conveyor 105 includes a decking 109, a first side wall 103, a second side wall 104, and at least one belt 106 or 107 that is rotatably attached to and/or attachable to the decking 109. In some embodiments, the decking 109 includes a top surface 108, a bottom surface (not shown), side surfaces (not shown), a loading end 101, and a delivery end 102. In embodiments, the delivery end 102 and the loading end 101 are positioned opposite of each other in the longitudinal direction and the feed conveyor 105 extends between the delivery end 102 and the loading end 101.

In one or more embodiments, the first and second side walls 103, 104 are integral with, attached to, and/or attachable to the decking 109. The first and second side walls 103, 104 may be positioned opposite to and spaced apart from one another in the lateral direction. The first and second side walls 103, 104 may be oriented substantially parallel to each other. In one or more embodiments, the first side wall 103 and the second side wall 104 extend from the loading end 101 to the delivery end 102 of the decking 109 along a length “l” thereof. In some embodiments, the first side wall 103 and the second side wall 104 of the agricultural apparatus 100 extend upward from the top surface 108 of the decking 109 of the feed conveyor 105 in the vertical direction.

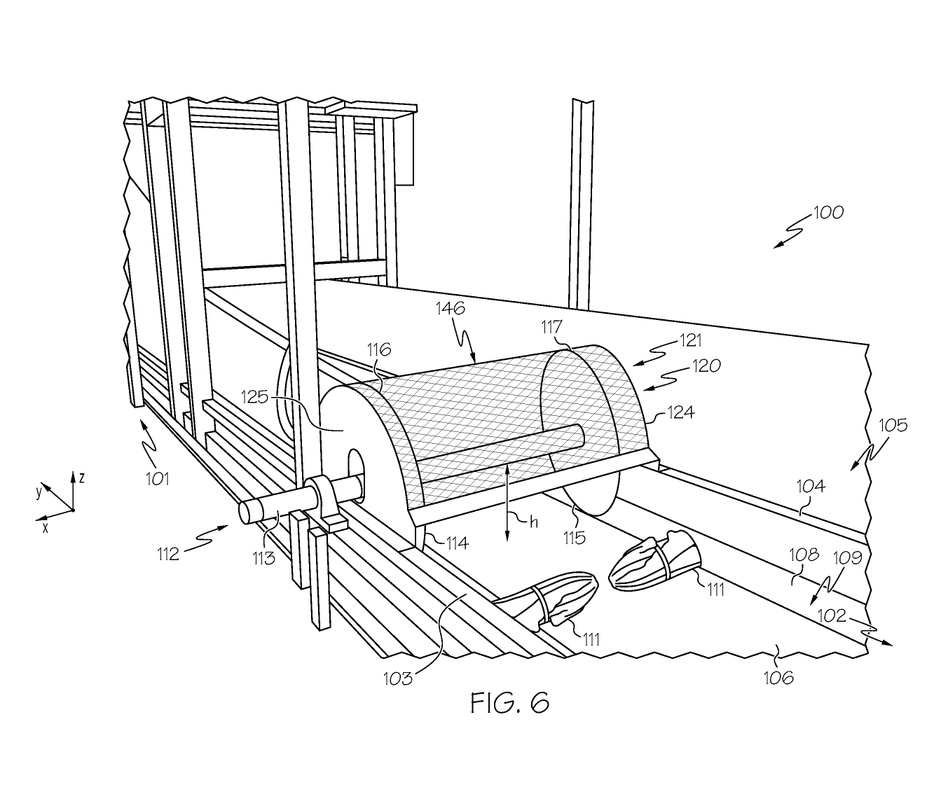

Referring now to FIG. 6, in one or more embodiments, the feed conveyor 105 includes at least one belt, i.e., a first belt 106. The first belt 106 may be positioned in between the first and second side walls 103, 104 in the lateral direction, respectively. The first belt 106 may extend from the loading end 101 to the delivery end 102 of the feed conveyor 105 in the longitudinal direction. More particularly, the first belt 106 may extend from the loading end 101 to the delivery end 102 of the feed conveyor 105 over the top surface 108, the bottom surface (not shown), and the side surfaces (not shown) of the decking 109.

Referring back to FIGS. 1A-2, in one or more embodiments, the feed conveyor 105 includes at least two belts, i.e., the first belt 106 and a second belt 107. The first belt 106 and the second belt 107 are positioned between the first side wall 103 and the second side wall 104 in the lateral direction. The first belt 106 and the second belt 107 may be spaced apart from each other in the lateral direction, such that the first belt 106 is proximate to the first side wall 103, the second belt 107 is proximate to the second side wall 104 and there is a gap in between the first belt 106 and the second belt 107. As the first belt 106 and the second belt 107 are spaced apart in the lateral direction, at least a portion of the top surface 108 of the decking 109 may be exposed therebetween.

The first belt 106 and the second belt 107 extend from the loading end 101 to the delivery end 102 of the feed conveyor 105. More particularly, the first belt 106 and the second belt 107 may extend from the loading end 101 to the delivery end 102 of the feed conveyor 105 over the top surface 108, the bottom surface, and the side surfaces of the decking 109. The first belt 106 and/or the second belt 107 each have a width, w₁ and w₂ evaluated in the lateral direction. In some embodiments, the widths w₁ and w₂ of the first and/or second belts 106, 107 are independently selected such that at least a portion of the top surface 108 of the decking 109 is visible therebetween. For example, the combined widths w₁ and w₂ may be less than a width w₃ of the decking 109.

Referring to FIG. 1B, in some embodiments, each of the first belt 106 and/or the second belt 107 includes a plurality of flights 146. In some embodiments, the flights 146 may be integral with, attached to, and/or attachable to the first and/or second belts 106, 107. In one or more embodiments, the flights 146 are fixedly attached to the first and/or second belts 106, 107. In some embodiments, each of the plurality of flights 146 is transversely oriented with respect to the first belt 106 and/or to the second belt 107. In some embodiments, the flights 146 extend across the widths w₁ or w₂ of the first and/or second belts 106, 107 in the lateral direction. The flights 146 retain the positioning of produce placed in between two of such flights 146 upon movement of the first and/or second belts 106, 107. In some embodiments, the flights 146 are spaced apart from one another such as to accommodate produce, e.g., romaine lettuce 111, positioned therein. Distances in between each of the flights 146 may be the same and/or different, and may vary dependent upon the type of produce to be accommodated.

In one or more embodiments, the feed conveyor 105 is powered. In some embodiments, the feed conveyor 105 is hydraulically powered, such as through a hydraulic motor. In further embodiments, wherein the agricultural apparatus 100 is mountable to farm equipment (not shown), the feed conveyor 105 is connected to a hydraulic motor (not shown) of a piece of farm equipment, such as a tractor. It is contemplated, however, that the feed conveyor 105 may be powered by energy sources known in the art, including but not limited to hydraulic power, gasoline or diesel power, and/or electric power.

In some embodiments wherein the feed conveyor 105 is powered, the first and/or second belts 106, 107 of the feed conveyor 105 are powered. For example, the feed conveyor 105 may include a drive unit 110, which is operatively engaged with the first and/or second belts 106, 107. The drive unit 110 may rotate, causing the first and/or second belts 106, 107 to move across the top surface 108 and around the decking, i.e., to move around the top surface 108, the side surfaces, and the bottom surface of the decking 109. By rotating the drive unit 110 and moving the first and/or second belts 106, 107 across the top surface 108 of the decking 109, the first and/or second belts 106, 107 are capable of moving produce, e.g., heads of romaine lettuce 111, from the loading end 101 to the delivery end 102 of the agricultural apparatus 100 in the longitudinal direction.

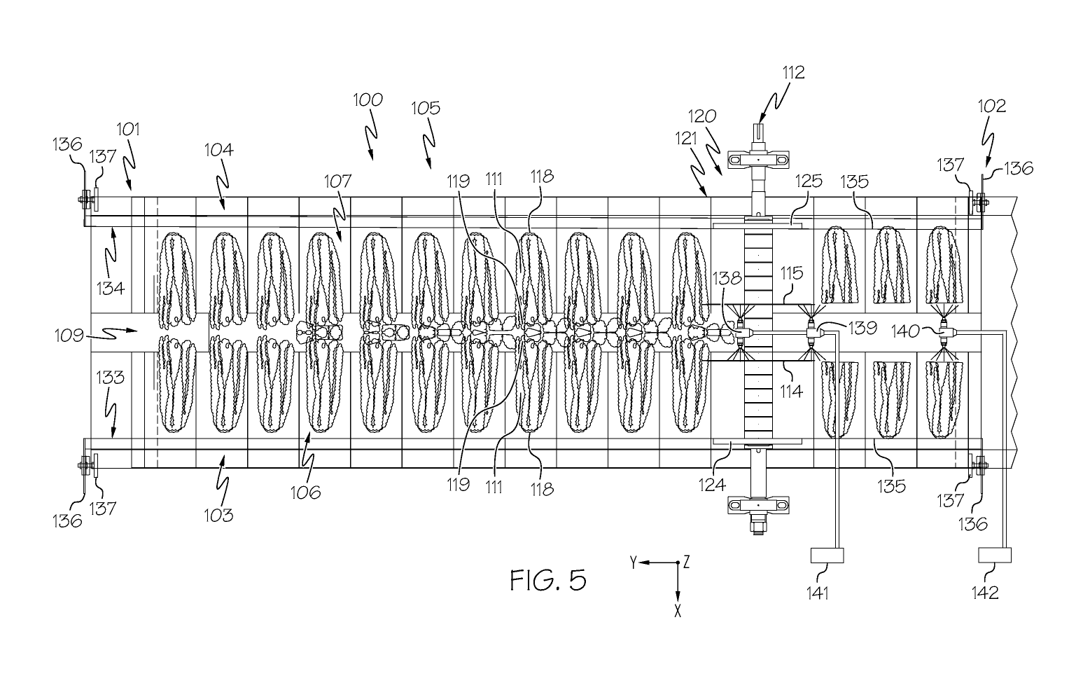

Referring now to FIG. 5, in one or more embodiments, the feed conveyor 105 includes at least one side rail, i.e., a first side rail 133. The first side rail 133 may be movably attached and/or movably attachable to the first side wall 103 or the second side wall 104. In this embodiment, the first side rail 133 extends along a length of the first side wall 103 or the second side wall 104 in the longitudinal direction, and may extend from the loading end 101 of the feed conveyor 105 to the delivery end 102 of the feed conveyor 105. In some embodiments, the first side rail 133 may extend along only a portion of the length of the first side wall 103 or the second side wall 104. In one or more embodiments, the first side rail 133 extends inward from the first side wall 103 or the second side wall 104 toward the exposed decking 109 in the lateral direction.

In alternative embodiments, the first side rail 133 may be movably attached and/or movably attachable to the decking 109 that is exposed in between the first and second belts 106, 107. In this embodiment, the first side rail 133 extends along a length of the decking 109 exposed in between the first and second belts 106, 107. In some embodiments, the first side rail 133 may extend along only a portion of the length of the decking 109. In this embodiment, the first side rail 133 may extend outward from the exposed decking 109 toward the first side wall 103 or the second side wall 104. The first side rail 133 may extend substantially parallel to the first side wall 103 and/or the second side wall 104.

In some embodiments, the feed conveyor 105 includes at least two side rails, i.e., a first side rail 133 and a second side rail 134. The first and second side rails 133, 134 may be movably attached and/or movably attachable to the first and second side walls 103, 104, respectively. Additionally, the first and second side rails 133, 134 may extend along the length of the first and second side walls 103, 104 respectively, extending from the loading end 101 to the delivery end 102 of the feed conveyor 105 in the longitudinal direction. In some embodiments, the first and second side rails 133, 134 may extend along only a portion of the length of the first side wall 103 or the second side wall 104. In one or more embodiments, the first side rail 133 extends inward from the first side wall 103 toward the exposed decking 109 in the lateral direction, and the second side rail 134 extends inward from the second side wall 104 toward the exposed decking 109 in the lateral direction.

In alternative embodiments, the first and second side rails 133, 134 may be movably attached and/or movably attachable to the decking 109 which is exposed in between the first and second belts 106, 107. In this embodiment, the first and second side rails 133, 134 extend along a length of the decking 109 exposed in between the first and second belts 106, 107, extending from the loading end 101 to the delivery end 102 of the feed conveyor 105. In some embodiments, the first and second side rails 133, 134 may extend along only a portion of the length of the decking 109. The first side rail 133 may extend outward from the exposed decking 109 toward the first side wall 103; similarly, the second side rail 134 may extend outward from the exposed decking 109 toward the second side wall 104. The first and second side rails 133 may extend substantially parallel to the first side wall 103 and/or the second side wall 104.

It is contemplated that the feed conveyor 105 may include any combination of first and second side rails 133, 134 as described herein. It is further contemplated that the feed conveyor 105 may include additional side rails, e.g., a third side rail (not shown), a fourth side rail (not shown), etc., as described herein with regard to the first and second side rails 133, 134.

Still referring to FIG. 5, in one or more embodiments, each of the first and second side rails 133, 134 includes a rail portion 135 and a slide portion 136. Each rail portion 135 of the first and second side rails 133, 134 extend in the longitudinal direction and may be used to guide produce placed on a top surface of the first and/or second belts, 106, 107 as the first and/or second belts 106, 107 move along the decking 109. Additionally, each rail portion 135 of the first and second side rails 133, 134 are moveably attached to the first and second side walls 103, 104 and may be used to adjust the positioning of produce placed on the top surface of the first and/or second belts, 106, 107. Such feature may provide workers with a mechanism to account for varying sizes, e.g., lengths, widths, etc., of produce, and will be described in greater detail below.

Each slide portion 136 is movably attached to the first side wall 103 or the second side wall 104. The slide portion 136 generally extends in the lateral direction and extends in a direction that is transverse to the slide portion 136. The slide portion 136 is operatively connected to the rail portion 135, such that the rail portion 135 is selectively translatable with respect to the first side wall 103 and/or the second side wall 104 in the lateral direction. For example, in one embodiment, the slide portion 136 is operatively connected to the rail portion 135 and the first and/or second side walls 103, 104 such that the rail portion 135 is slidably movable inward in the lateral direction toward the exposed decking 109 and/or is slidably movable outward in the lateral direction toward the first and/or second side walls 103, 104 respectively. Each of the first side rail 133 and the second side rail 134 may be slidably moved inward or outward from the first side wall 103 and the second side wall 104 respectively in the lateral direction. By moving the first side rail 133 and/or the second side rail 134 inward and/or outward from the first and/or second side walls 103, 104, the positioning of produce, e.g., heads of romaine lettuce 111, placed on the first and/or second belts 106, 107 may be adjusted. More particularly, the positioning of produce, e.g., heads of romaine lettuce 111, placed on the first and/or second belts 106, 107 may be adjusted with respect to rotating blades 114, 115 in the processing station 120 (which will be described in greater detail below).

In one or more embodiments, each of the slide portions 136 includes a plurality of tee handles 137. The tee handles 137 may engage the slide portion 136 of the first and/or second side rails 133, 134, respectively, retaining the slide portion 136 in place. The plurality of tee handles 137 includes spring loaded pins (not shown) that engage holes in the slide portion 136, allowing a worker to set and/or adjust the position of the first and/or second side rails 133, 134 at a number of predetermined positions. It is further contemplated, however, that the position of the first and/or second side rails 133, 134 may be set, adjusted, and/or retained by alternative mechanisms known in the art, such as, for example, a spring loaded tee handle engaging a slot and/or a set screw.

By way of example, the decking 109, first side wall 103, second side wall 104, first side rail 133, and second side rail 134, may be made from materials such as, e.g., metals, which are appropriate for use in agricultural apparatus. Such material may include, but should not be limited to, stainless steel and/or aluminum.

Referring now to FIGS. 1A-2, in one or more embodiments, the agricultural apparatus 100 includes the processing station 120 operatively connected to the feed conveyor 105. In some embodiments, the processing station 120 includes a housing 121, a mandrel assembly 112 integral with, attached to, and/or attachable to the housing 121, a cutting board 130 attached to the decking 109, and/or a byproduct drop-off 131 defined by the cutting board 130 and/or the decking 109. The housing 121 may be integral with, attached to, and/or attachable to the feed conveyor 105. In one or more embodiments, the housing 121 includes a first wall 124, e.g., a first side wall, a second wall 125, e.g., a second side wall, and a top wall 126. The first wall 124 and the second wall 125 are adjacent to and attached to the top wall 126. In some embodiments, the first wall 124 and the second wall 125 respectively extend vertically upward in the vertical direction from the first side wall 103 and the second side wall 104 of the feed conveyor 105. In further embodiments, the first wall 124 and the second wall 125 are respectively mounted to the first side wall 103 and the second side wall 104 of the feed conveyor 105.

In some embodiments, the housing 121 further includes a front wall 150. In these embodiments, the front wall 150 is adjacent to the top wall 126 and to the first wall 124 and the second wall 125. In one or more embodiments, the front wall 150 extends downwardly from the top wall 126 toward the top surface 108 of the decking 109 in the vertical direction, while providing sufficient space therebetween to allow the entrance of produce into the housing 121. In this way, the housing 121 at least partially encapsulates the first and/or the second rotating blades 114, 115. In some embodiments, the housing 121 may prevent and/or protect workers from inadvertently contacting the mandrel assembly 112 and/or first and second rotating blades 114, 115 provided therein, which are described in greater detail below. In further embodiments, the housing 121 and/or a portion thereof may include a cage-like material. For example, as shown in FIGS. 1A and 1B, in one or more embodiments, the front wall 150 of the housing 121 is a cage wall. The use of such a cage wall allows workers to see within the processing station 120 and/or housing 121, while preventing inadvertent contact with the first and/or second rotating blades 114, 115.

While the housing 121 may prevent inadvertent contact with the first and/or second rotating blades 114, 115, in some embodiments, an opto-electronic device (not shown), such as, e.g., a light curtain, may be used to prevent such inadvertent contact. When such an opto-electronic (not shown) is utilized, a controller (not shown) may be provided in communication with the mandrel assembly 112 and with the opto-electronic device (not shown), such that when an object interrupts the opto-electronic device, the opto-electronic device sends a signal to the controller, and the controller commands the mandrel assembly 112 to stop the rotation of the first and/or second rotating blade 114, 115. In other embodiments, each of the first and/or second rotating blades 114, 115 may include protective covers (not shown) to prevent inadvertent contact with the first and/or second rotating blades 114, 115.

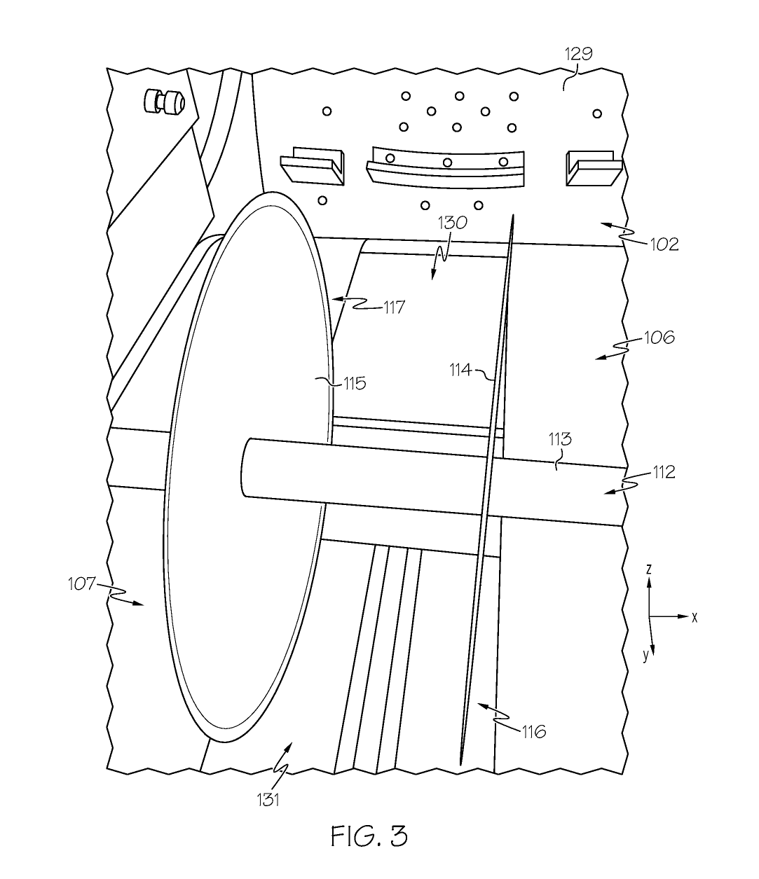

Referring to FIGS. 2-3, in some embodiments, the mandrel assembly 112 is partially or wholly encapsulated within the housing 121. The mandrel assembly 112 may include an axle 113 and/or at least one rotating blade, i.e., a first rotating blade 114. Alternatively, the mandrel assembly 112 may include an axle 113 and/or at least two rotating blades, i.e., a first rotating blade 114 and a second rotating blade 115. In one or more embodiments, the mandrel assembly 112 is positioned proximate to the delivery end 102 of the agricultural apparatus 100 in the longitudinal direction and/or above the feed conveyor 105 in the vertical direction.

Referring specifically to FIG. 2, the axle 113 is integral with, attached to, and/or attachable to the feed conveyor 105. In a further embodiment, the axle 113 is fixedly attached to the feed conveyor 105. In some embodiments, the axle 113 of the mandrel assembly 112 extends through a first opening 122 and a second opening 123 in the housing 121. In further embodiments, the first and second openings 122, 123 in the housing 121 are configured such that the axle 113 is free to rotate therein. In one or more embodiments, such as is shown in FIGS. 1A and 1B, the axle 113 is positioned at a height h above the top surface 108 of the decking 109 of the feed conveyor 105 in the vertical direction. The height h may be selected such that an outer edge 116 of the first rotating blade 114 and an outer edge 117 of the second rotating blade 115 extend at least to the first belt 106 and the second belt 107 on the top surface 108 of the decking 109. By selecting height h such that the outer edge 116 the first rotating blade 114 and the outer edge 117 of the second rotating blade 115 extend at least to the first belt 106 and second belt 107, the first rotating blade 114 and second rotating blade 115 are positioned so as to fully cut through the produce, e.g., heads of romaine lettuce 111 passing from the loading end 101 to the delivery end 102 of the agricultural apparatus 100.

The first rotating blade 114 and/or the second rotating blade 115 may be operatively connected to the axle 113, such that when the axle 113 is rotated, the first and second rotating blades 114, 115 are rotated. For example, in one or more embodiments, the first rotating blade 114 and/or the second rotating blade 115 are fixedly attached to the axle 113 such that rotation of the axle 113 provides rotation of the first and second rotating blades 114, 115. In some embodiments, the first and/or second rotating blades 114, 115, respectively, are axially positioned over the exposed portion the top surface 108 of the decking 109 in the lateral direction, positioned between the first and second belts 106, 107, respectively. In this particular embodiment, the first and/or second rotating blades 114, 115, are centrally attached to and positioned along a length of the axle 113 (such as is shown, e.g., in FIGS. 1-2 and 4-5). Such central positioning of the first and/or second rotating blades 114, 115 may be provided wherein the feed conveyor 105 includes a first and second belt 106, 107, respectively. However, such central positioning of the first and/or second rotating blades 114, 115 may also be provided wherein the feed conveyor 105 includes a first belt 106 only.

In alternative embodiments, the first and/or second rotating blades 114, 115, respectively, are outwardly attached to and/or positioned along outer edges of the axle 113 in the lateral direction (such as is shown, e.g., in FIG. 6). In these embodiments, the first and second rotating blades 114, 115 attached to and/or are respectively positioned on the axle 113 on the outside of the first belt 106 proximate to the first wall 124 and the second wall 125 of the housing 121 in the lateral direction. Also in these embodiments, the first and/or second rotating blades 114, 115, may be positioned over an exposed portion of the top surface 108 of the decking 109, wherein the exposed portion is provided along outer edges (not shown) of the decking 109. Such outward positioning of the first and/or second rotating blades 114, 115 may be provided wherein the feed conveyor 105 includes a first belt 106 only. However, such outward positioning of the first and/or second rotating blades 114, 115 may also be provided wherein the feed conveyor 105 includes a first and second belt 106, 107, respectively (and any additional belts). Attachment and/or positioning of the first and/or second rotating blades 114, 115, over exposed portion(s) of the top surface 108 of the decking 109 may prevent damage to the first and/or second belts 106, 107 caused by rotation of the first and/or second rotating blades 114. 115.

In one or more embodiments, the first and/or second rotating blades 114, 115 are substantially circular in shape. In this embodiment, when operatively connected to the axle 113, the first and/or second rotating blades 114, 115 extend radially outward from the axle 113. The outer edge 116, e.g., circumference, of the first rotating blade 114 and the outer edge 117, e.g., circumference, of the second rotating blade 115 may be sharpened. While the outer edges 116 and 117 of the first and second rotating blades 114, 115, respectively, are sharpened in some embodiments, it is also contemplated that the first and second rotating blades 114, 115, may include sharpened teeth, a serrated edge, and/or any edge suitable for cutting produce.

The first and/or second rotating blades 114, 115 may be made from any material suitable for use in cutting produce. For example, in one embodiment, the first and/or second rotating blades 114, 115 may be made from stainless steel.

In one or more embodiments, the mandrel assembly 112 is hydraulically powered. In further embodiments, the mandrel assembly 112 is configured to be connected to a hydraulic motor (not shown). In still further embodiments, wherein the agricultural apparatus 100 is mountable to farm equipment (not shown), the mandrel assembly 112 is configured to be connected to a hydraulic motor (not shown) of a piece of farm equipment, e.g., a tractor. It is contemplated, however, that the mandrel assembly 112 may be powered by energy sources known in the art, including but not limited to hydraulic power, gasoline or diesel power, and/or electric power.

In one or more embodiments, referring to FIG. 5, the processing station 120 includes a first and/or second spray assembly 141, 142, respectively. The first spray assembly 141 may be integral with, attached to, and/or attachable to the housing 121. The second spray assembly 142 may be positioned within or outside of the housing 121 and may be integral with, attached to, and/or attachable to the decking 109 of the feed conveyor 105 and/or attached to the housing 121.

In one or more embodiments, the first spray assembly 141 may include at least one spray nozzle. In further embodiments, the first spray assembly 141 includes a plurality of spray nozzles mounted within the housing 121. In one particular embodiment, the first spray assembly 141 includes a first spray nozzle 138 and a second spray nozzle 139. The first and second spray nozzles 138, 139, respectively, are in fluid communication with a fluid receptacle (not shown).

In some embodiments, the first and second spray nozzles 138, 139 coupled to the feed conveyor 105 and are positioned within the housing 121 and/or spray a fluid onto the first and/or second rotating blades 114, 115. More specifically, in some embodiments, the first and second spray nozzles 138, 139 dispense and/or spray a fluid onto the first and/or second rotating blades 114, 115 in order to provide sanitation thereto and/or to cool the first and/or second rotating blades 114, 115. In some embodiments, the first and second spray nozzles 138, 139 are positioned between the first and second rotating blades 114, 115 in the lateral direction. In alternative embodiments, the first and second spray nozzles 138, 139, may be respectively positioned in between the first rotating blade 114 and the first wall 124 and/or in between the second rotating blade 115 and the second wall 125 in the lateral direction. In another embodiment, the first spray nozzle 138 is positioned in between the first and second rotating blades 114, 115, and the second spray nozzle 139 is positioned in between the second rotating blade 115 and the second wall 125 or the first rotating blade 114 and the first wall 124 in the lateral direction. It is contemplated, however, that the first and second spray nozzles 138, 139 may be positioned in any position such that they may spray a liquid onto the first and/or second rotating blades 114, 115.

In one or more embodiments, the second spray assembly 142 may include at least one spray nozzle. In further embodiments, the second spray assembly 142 includes a plurality of spray nozzles mounted within the housing 121. In one particular embodiment, the second spray assembly 142 includes a third spray nozzle 140 and/or a fourth spray nozzle (not shown) coupled to the feed conveyor 105. The third and/or fourth spray nozzles 140 and not shown, respectively, are in fluid communication with a fluid receptacle (not shown). In some embodiments, the third and fourth spray nozzles, 140 and not shown, are positioned within the housing 121 and spray a liquid onto produce which has been cut by the first and/or second rotating blades 114, 115. The fluid, such as, e.g., a cleansing liquid, which is dispensed by the third and/or fourth nozzles, 140 and not shown, onto the freshly cut produce may act to seal the produce. For example, wherein the produce cut by the first and/or second rotating blades 114, 115 is romaine lettuce 111, the fluid dispensed by the third and/or fourth nozzles, 140 and not shown, may act to seal the freshly cut leaves. By sealing the freshly cut heads of romaine lettuce 111, the romaine lettuce may be sanitized and better preserved for transportation and/or further processing.

In some embodiments, the third and fourth spray nozzles, 140 and not shown, may be positioned within the housing 121 proximate to the delivery end 102 of the feed conveyor 105 in the longitudinal direction. The third and fourth spray nozzles, 140 and not shown, are positioned between the delivery end 102 than the first and/or second rotating blades 114, 115 in the longitudinal direction, such that they may spray onto produce which has been cut thereby. For example, in one embodiment wherein romaine lettuce 111 is fed into the housing 121 by the feed conveyor 105, after a top portion of the head of romaine lettuce 111 has been removed by the first and/or second rotating blades 114, 115, a smooth, internal surface of the romaine lettuce 111 is exposed. The third and fourth spray nozzles, 140 and not shown, may be positioned within the housing 121 such that they spray directly onto the smooth surface of the cut romaine lettuce 111 (and/or other types of produce). In further embodiments, the third and fourth spray nozzles 140 and not shown are positioned within the housing 121 such that they may spray substantially centrally onto a cut surface of produce.

Each of the first and second spray assemblies 141, 142 may spray a cleaning fluid onto the first and second rotating blades 114, 115 and the cut produce, respectively. The fluid, e.g., liquid, sprayed by the first and/or second spray assemblies 141, 142 may include any cleansing fluid suitable for sanitizing equipment utilized for collecting, cutting, and/or processing produce and/or for sanitizing produce. By way of example, the cleansing fluids may include, but are not limited to chlorinated water, water, and/or salt solutions. In some embodiments, the first spray assembly 141 and the second spray assembly 142 are equipped with the same cleansing fluid. In alternative embodiments, the first spray assembly 141 and the second spray assembly 142 are equipped with different cleansing fluids.

Referring to FIG. 2, in one or more embodiments, the processing station 120 includes at least one cutting board 130. In some embodiments, the cutting board 130 is positioned on the top surface 108 of the exposed decking 109. In further embodiments, the cutting board 130 is positioned on the top surface 108 of the exposed decking 109 directly beneath the first and/or the second rotating blades 114, 115 in the vertical direction. In still further embodiments, the cutting board 130 is positioned on the top surface 108 of the exposed decking 109 in between the first belt 106 and/or second belt 107 directly beneath the first and/or second rotating blades 114, 115. In this way, the cutting board 130 may be readily replaced in the event that the first and/or second rotating blades 114, 115, cause damage thereto. The cutting board 130 may be fastened and/or attached to the exposed portion of the decking 109 such that a top surface of the cutting board 130 is substantially level with the top surface 108 of the exposed portion of the decking 109.

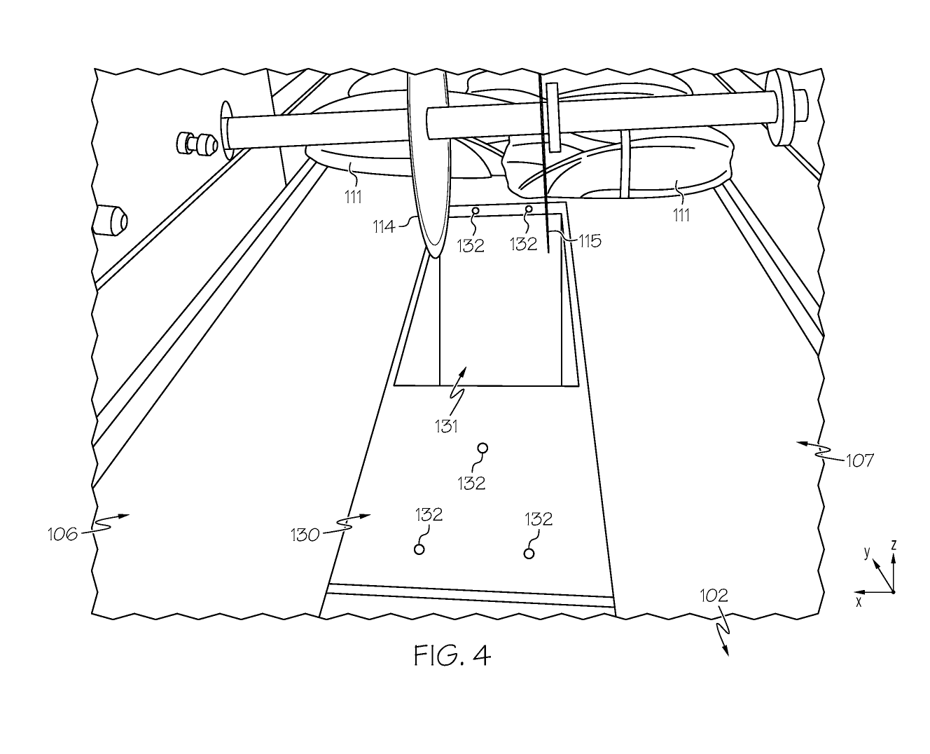

In some embodiments, such as the embodiment depicted in FIG. 4, the cutting board 130 may be fastened to the decking 109 by use of appropriate fasteners, e.g., at least one screw 132, nails, nuts, bolts, epoxy, and/or glue. By way of example, the cutting board may be made from a variety of materials, including but not limited to, ultra high molecular weight polyethylene (i.e., UHMW), nylon, and/or other thermoplastic resins known in the art.

Referring now to FIG. 3, in one or more embodiments, the processing station 120 includes a byproduct drop-off 131. In some embodiments, the byproduct drop-off 131 is positioned in between the first belt 106 and the second belt 107 of the feed conveyor 105. The byproduct drop-off 131 may be positioned between the first rotating blade 114 and the second rotating blade 115 in the lateral direction. The byproduct drop-off 131 is a cavity defined by the cutting board 130 and/or the decking 109. The byproduct drop-off 131 serves to remove a portion of the product cut by the first and/or second rotating blades 114, 115. For example, when produce e.g., romaine lettuce 111, is moved from the loading end 101 to the delivery end 102 of feed conveyor 105, top portions, i.e., tips of the romaine lettuce leaves 119, are severed by the first rotating blade 114 and/or the second rotating blade 115 prior to encountering the byproduct drop-off 131. Once severed, the top portions of the produce will fall through the byproduct drop-off 131, and the remainder of the produce will continue moving toward the delivery end 102 of the feed conveyor 105. In some embodiments, a collection and/or storage receptacle may be placed beneath the byproduct drop-off 131 for collection of produce therein.

In some embodiments, referring to FIGS. 1A-2, the agricultural apparatus 100 includes a collection conveyor 129 connected to and/or operatively connected to the delivery end 102 of the feed conveyor 105. The collection conveyor 129 may include a loading end (not shown), a delivery end (not shown), a decking (not shown), a first side wall (not shown) integral with, attached to, and/or attachable to the decking (not shown), a second side wall (not shown) integral with, attached to, and/or attachable to the decking (not shown), and at least one belt 106 rotatably attached to and/or attachable to the decking (not shown). Such features are as previously described with regard to the feed conveyor 105. Additionally, the collection conveyor 129 may be powered as previously described with regard to the feed conveyor 105.

In further embodiments, the collection conveyor 129 may be elevated. For example, the loading end (not shown) of the collection conveyor 129 may be provided at a position substantially aligned with the delivery end 102 of the feed conveyor 105 such that cut and/or processed produce may be easily transported from the delivery end 102 of the feed conveyor 105 to the loading end (not shown) of the collection conveyor 129. However, the delivery end (not shown) of the collection conveyor 129 may be positioned at a height substantially greater than that of its loading end (not shown) and/or that of the delivery end 102 of the collection conveyor 129. Such elevation of the collection conveyor 129 may function to transport cut and/or processed produce from the feed conveyor 105 to a storage receptacle. In some embodiments, such storage receptacles may be placed on a piece of farm equipment.

In some embodiments, the agricultural apparatus 100 includes a third conveyor 128 operatively connected to the loading end 101 of the feed conveyor 105. The third conveyor 128 may be configured to convey heads of romaine lettuce 111 to the loading end 101 of the feed conveyor 105. Additionally, the third conveyor may include the features of the feed conveyor 105 as previously described.

Embodiments of agricultural apparatus have been described in detail. Embodiments of methods of collecting, cutting, and/or processing produce will now be described with reference to FIGS. 1A-7.

II. Methods for Collecting, Cutting, and/or Processing Produce

In one or more embodiments, methods of collecting, cutting, and/or processing produce utilizing the agricultural apparatus 100 as previously described herein are disclosed. In some embodiments, the methods include loading produce onto the feed conveyor 105, transporting the produce into the processing station 120, cutting the produce with the mandrel assembly 112 within the processing station 120, removing a portion of the cut produce with a byproduct drop-off 131 within the processing station 120, sanitizing the produce with the first and/or second spray assemblies 141, 142 within the processing station 120, transporting the produce from the processing station 120 to the collection conveyor 129, and/or transporting the produce to a storage receptacle (not shown).

Referring initially to FIG. 1A, in one or more embodiments, produce, such as e.g., romaine lettuce 111, is loaded onto the feed conveyor 105. The produce may be loaded at or near the loading end 101 of the feed conveyor 105 by placing the produce onto the first and/or second belt 106, 107. In some embodiments, the produce should be positioned on the first and/or second belt 106, 107 such that the produce will come into contact with the mandrel assembly 112 upon movement through the processing station 120. More particularly, in some embodiments, the produce should be positioned on the first and/or second belt 106, 107 such that the portion of the produce of which removal is desired is aligned with the first and/or second rotating blades 114, 115.

With particular regard to romaine lettuce 111, as shown in FIG. 1, when the first and/or second rotating blades 114, 115 are centrally positioned, heads of the romaine lettuce 111 are placed onto the first belt 106 in an orientation wherein a base 118 thereof is proximate to the first side wall 103. Similarly, heads of romaine lettuce 111 may be placed on the second belt 107 in an orientation wherein the base 118 is proximate to the second side wall 104. In some embodiments, the first and/or second side walls 103, 104 restrict the position of the base 118 of the heads of romaine lettuce 111 such that top portion or tips of the romaine lettuce leaves 119 opposite the base 118 are positioned over the partially exposed top surface 108 decking 109 of the feed conveyor 105.

With particular regard to romaine lettuce 111, referencing FIG. 6, when the first and/or second rotating blades 114, 115 are positioned on the outside of the feed conveyor 105, heads of romaine lettuce 111 are loaded onto the feed conveyor 105 with the tips of the romaine lettuce leaves 119 proximate to and/or facing either the first side wall 103 or the second side wall 104, and with the base 118 of the head of romaine lettuce 111 toward a center of the feed conveyor 105.

In embodiments wherein the feed conveyor 105 includes first and/or second side rails 133, 134, the first and/or second side rails 133, 134 may be slidably adjusted to accommodate for produce of varying size. In some embodiments, the first and/or second side rails 133, 134 may be adjusted by moving the rail portions 135 thereof inwardly and/or outwardly toward the exposed decking 109 and/or the first and/or second side walls 103, 104.

With particular regard to romaine lettuce 111, referencing FIG. 5, when the first side rail 133 is moved inward, away from the first side wall 103, the base 118 of the heads of romaine lettuce 111 may be moved closer to the first rotating blade 114. As a result, more of the heads of romaine lettuce 111 may be removed upon contact with the first rotating blade 114. When the first side rail 133 is moved outward, closer to the first side wall 103, the base 118 of the head of romaine lettuce 111 is moved farther away from the first rotating blade 114. As a result, less of the heads of romaine lettuce 111 may be removed upon contact with the first rotating blade 114. The second side rail 134 may be slidably moved inward or outward with relation to the second side wall 104, similarly altering the amount of the heads of romaine lettuce 111 cut by the second rotating blade 115.

Upon loading the produce onto the feed conveyor 105, the produce may be transported into the processing station 120. Movement of the first and/or second belts 106, 107 of the feed conveyor 105 may be achieved upon powering. Upon powering, the first and/or second belts 106, 107 may begin rotating, causing the produce placed thereon to move across the top surface of the decking 109. During such movement (and also while stationary), the first and/or second side walls 103, 104 and/or the first and/or second side rails 133, 134 may act to guide the produce, e.g., heads of romaine lettuce 111, as the first belt 106 and/or the second belt 107 move the produce from the loading end 101 toward the delivery end 102, thus transporting the produce into the processing station 120.

Upon transporting the produce into the processing station 120, continued movement of the first and/or second belts 106, 107 will bring the produce into contact with the first and/or second rotating blades 114, 115, when properly aligned. Such contact will result in the produce being cut.

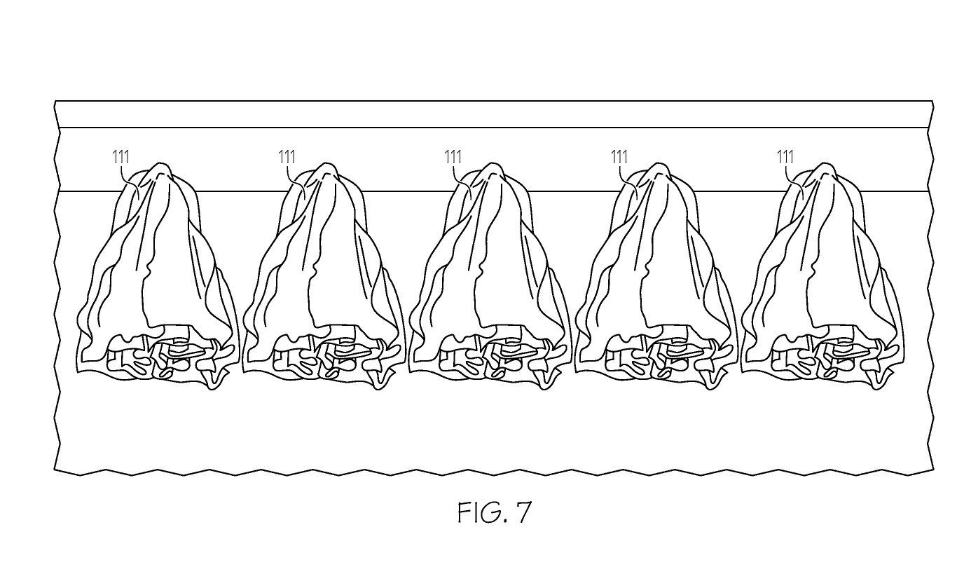

With particular regard to heads of romaine lettuce 111, movement of the first and/or second belts 106, 107 may bring the heads of romaine lettuce 111 placed thereon into contact with the first and/or second rotating blades 114, 115. Such contact with the first and/or second rotating blades 114, 115, will result in severing the top portion or tips of the romaine lettuce leaves 119 from the heads of romaine lettuce. During such cutting process, the first spray assembly 141 may dispense a cleansing fluid onto the first and/or second rotating blades 114, 114. Turning to FIG. 7, cut heads of romaine lettuce 111 are depicted. The tips of the leaves of the romaine lettuce have been severed from the heads of lettuce in a clean and straight cut that is uniform across the heads of romaine lettuce 111.

Upon cutting of the produce with the mandrel assembly 112, a portion of the cut produce may be removed from the feed conveyor 105 by dropping into the byproduct drop-off 131. If desired, cut produce may be collected in a storage receptacle beneath the byproduct drop-off 131.

Upon cutting of the produce with the mandrel assembly 112, the produce may be sanitized. More particularly, continued movement of the first and/or second belts 106, 107 may bring the produce into a region wherein the second spray assembly 142 may dispense a cleansing fluid onto the cut surface of the produce. More particularly, with regard to heads of romaine lettuce, referencing FIG. 5, continued movement of the first and/or second belts 106, 107 toward the delivery end 102 of the agricultural apparatus 100 bring the heads of romaine lettuce into contact with a spray of fluid as the romaine lettuce 111 exits the first rotating blade 114 and second rotating blade 115. In some embodiments, the cleansing fluid is sprayed centrally onto the cut surface of the romaine lettuce. Such procedure may provide clean produce.

Upon sanitizing the produce, the produce may be transported from the processing station 120 to the collection conveyor 129. Continued movement of the first and/or second belts 106, 107 will transport the produce to the delivery end 102 of the feed conveyor 105 and onto the loading end (not shown) of the collection conveyor 129. Upon powering of the collection conveyor 129, the produce delivered thereon may move across a top surface of the decking thereof to a storage receptacle.

In some embodiments, such methods may be performed in the field only. In other embodiments, such methods may be performed in a processing facility.

The terms “a,” “an,” and “the”, as used herein, refer to “one or more.” For example, reference to “an apparatus” may include both reference to a single apparatus and reference to a plurality of apparatus.

It is to be further understood that where descriptions of various embodiments use the term “comprising,” and/or “including” those skilled in the art would understand that in some specific instances, an embodiment can be alternatively described using language “consisting essentially of” or “consisting of.”

While particular embodiments of the present disclosure have been illustrated and described, it would be obvious to one skilled in the art that various other changes and modifications can be made without departing from the spirit and scope of the disclosure. It is therefore intended to cover in the appended claims all such changes and modifications that are within the scope of this disclosure.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

What is claimed is:

1. An agricultural apparatus for collecting, cutting, and/or processing produce, the agricultural apparatus comprising:
a feed conveyor that extends between a loading end and a delivery end in a longitudinal direction, wherein the feed conveyor comprises:
a first belt that extends between the loading end and the delivery end of the feed conveyor in the longitudinal direction; and
a second belt that extends between the loading end and the delivery end of the feed conveyor in the longitudinal direction, wherein the second belt is spaced apart from the first belt in a lateral direction; and
a processing station, the processing station comprising:
a housing mounted to the feed conveyor;
an axle attached to the feed conveyor;
a first rotating blade operatively connected to the axle; and
a second rotating blade operatively connected to the axle, wherein the second rotating blade is spaced apart from the first rotating blade in the lateral direction, and wherein the first rotating blade and the second rotating blade are positioned between the first belt and the second belt in the lateral direction and are at least partially encapsulated by the housing, wherein the first rotating blade and the second rotating blade cut through produce passing from the loading end to the delivery end of the feed conveyor.

2. The agricultural apparatus of claim 1, wherein the feed conveyor comprises a decking having a top surface, and wherein the first belt and the second belt extend over the top surface of the decking.

3. The agricultural apparatus of claim 2, wherein the feed conveyor further comprises a first side wall that extends upward from the top surface of the decking.

4. The agricultural apparatus of claim 3, wherein the feed conveyor further comprises a second side wall that extends upward from the top surface of the decking, wherein the first side wall and the second side wall are spaced apart from one another in the lateral direction.

5. The agricultural apparatus of claim 3, wherein the feed conveyor further comprises a first side rail that is movably attached to the first side wall.

6. The agricultural apparatus of claim 2, wherein the feed conveyor further comprises a cutting board attached to the decking and positioned beneath the first rotating blade and the second rotating blade in a vertical direction.

7. The agricultural apparatus of claim 2, wherein the feed conveyor further comprises a byproduct drop-off defined by the decking and positioned between the first rotating blade and the second rotating blade in the lateral direction.

8. The agricultural apparatus of claim 1, further comprising a first spray assembly having a first spray nozzle coupled to the feed conveyor and positioned between the first rotating blade and the second rotating blade in the lateral direction.

9. The agricultural apparatus of claim 1, further comprising a second spray assembly attached to the housing and having a third spray nozzle that is positioned between the first rotating blade and the second rotating blade and the delivery end of the feed conveyor in the longitudinal direction.

10. An agricultural apparatus for collecting, cutting, and/or processing produce, the agricultural apparatus comprising:
a feed conveyor that extends between a loading end and a delivery end in a longitudinal direction, wherein the feed conveyor comprises:
a first belt that extends between the loading end and the delivery end of the feed conveyor in the longitudinal direction; and
a second belt that extends between the loading end and the delivery end of the feed conveyor in the longitudinal direction, wherein the second belt is spaced apart from the first belt in a lateral direction; and
a processing station, the processing station comprising:
a housing mounted to the feed conveyor;
an axle attached to the feed conveyor;
a first rotating blade operatively connected to the axle; and
a second rotating blade operatively connected to the axle, wherein the second rotating blade is spaced apart from the first rotating blade in the lateral direction, wherein the first rotating blade and the second rotating blade are at least partially encapsulated by the housing and wherein the first rotating blade and the second rotating blade cut through produce passing from the loading end to the delivery end of the feed conveyor; and
a spray nozzle that dispenses a fluid, wherein the spray nozzle is coupled to the feed conveyor and positioned between the first rotating blade and the second rotating blade in the lateral direction.

11. The agricultural apparatus of claim 10, wherein the feed conveyor comprises a decking having a top surface, and wherein the first belt and the second belt extend over the top surface of the decking.

12. The agricultural apparatus of claim 11, wherein the feed conveyor further comprises a first side wall that extends upward from the top surface of the decking.

13. The agricultural apparatus of claim 12, wherein the feed conveyor further comprises a second side wall that extends upward from the top surface of the decking, wherein the first side wall and the second side wall are spaced apart from one another in the lateral direction.

14. The agricultural apparatus of claim 12, wherein the feed conveyor further comprises a first side rail that is movably attached to the first side wall.

15. The agricultural apparatus of claim 11, wherein the feed conveyor further comprises a cutting board attached to the decking and positioned beneath the first rotating blade and the second rotating blade in a vertical direction.

16. The agricultural apparatus of claim 11, wherein the feed conveyor further comprises a byproduct drop-off defined by the decking and positioned between the first rotating blade and the second rotating blade in the lateral direction.

17. An agricultural apparatus for collecting, cutting, and/or processing produce, the agricultural apparatus comprising:
a feed conveyor that extends between a loading end and a delivery end in a longitudinal direction, the feed conveyor comprising:
a top surface that extends between the loading end and the delivery end in the longitudinal direction;
a first side wall that extends upward from the top surface in a vertical direction;
a first side rail that is movably attached to the first side wall, the first side rail comprising a rail portion that extends in the longitudinal direction and a slide portion that extends in a lateral direction, wherein the slide portion is operatively connected to the rail portion and is movably attached to the first side wall such that the rail portion is selectively translatable with respect to the first side wall in the lateral direction;
a first belt that extends between the loading end and the delivery end of the feed conveyor in the longitudinal direction; and
a second belt that extends between the loading end and the delivery end of the feed conveyor in the longitudinal direction, wherein the second belt is spaced apart from the first belt in the lateral direction; and
a processing station, the processing station comprising:
a housing mounted to the feed conveyor;
an axle attached to the feed conveyor;
a first rotating blade operatively connected to the axle; and
a second rotating blade operatively connected to the axle, wherein the first rotating blade and the second rotating blade cut through produce passing from the loading end to the delivery end of the feed conveyor.

18. The agricultural apparatus of claim 17, wherein the first rotating blade and the second rotating blade are positioned between the first belt and the second belt in the lateral direction.

19. The agricultural apparatus of claim 17, further comprising a spray nozzle attached to the housing and positioned between the first rotating blade and the second rotating blade in the lateral direction.

20. The agricultural apparatus of claim 17, wherein the feed conveyor defines a byproduct drop-off positioned between the first rotating blade and the second rotating blade in the lateral direction.
